(19) United States
(12) Patent Application Publication
(10) Pub. No.: US 2017/0090230 A1
(43) Pub. Date: Mar. 30, 2017

(54) DISPLAY APPARATUS AND DIGITAL INFORMATION DISPLAY DEVICE INCLUDING A PLURALITY OF DISPLAY APPARATUSES

(71) Applicant: Samsung Display Co., Ltd., Yongin-Si (KR)

(72) Inventors: Won-gap YOON, Suwon-si (KR); Byung-chul KIM, Asan-si (KR); Jaehong PARK, Seoul (KR); Sanghee YU, Hwaseong-si (KR); Youngjoo JEON, Seoul (KR); Kyungseon TAK, Hwaseong-si (KR)

(21) Appl. No.: 15/135,719

(22) Filed: Apr. 22, 2016

(30) Foreign Application Priority Data
Sep. 30, 2015 (KR) 10-2015-0138120

(51) Int. Cl. G02F 1/1333

(52) U.S. Cl. CPC G02F 1/13336; G02F 1/133308; G02F 2001/13332

(57) ABSTRACT

A display apparatus includes a display panel, a backlight unit and a top cover. The display panel defines a display area and a non-display area adjacent to the display area. The top cover is coupled to the display panel and the backlight unit and exposes the display area. The top cover includes a base portion and a side portion provided in plural. The base portion is parallel to the display panel to cover the non-display area of the display panel. Each of the side portions is connected to the base portion and extends in a direction perpendicular to the non-display area. In a top plan view, the base portion is disposed between the side portions and the display area.

This application claims priority to Korean Patent Application No. 10-2015-0138120, filed on Sep. 30, 2015, and all the benefits accruing therefrom under 35 U.S.C. §119, the content of which in its entirety is hereby incorporated by reference.

### BACKGROUND

(1) Field

The invention disclosed herein relates to a display apparatus and a digital information display (“DID”) device including a plurality of display apparatuses therein, and more particularly, to a display apparatus and a DID device including a plurality of display apparatuses therein, which are capable of decreasing a non-display area.

(2) Description of the Related Art

Display apparatuses may be classified into a light emitting type display apparatus which self-emits light to display an image and a light receiving type display apparatus which receives light to display an image. The light receiving type display apparatus includes, e.g., liquid crystal display devices, electrowetting display devices and eletrophoretic display devices.

### SUMMARY

One or more exemplary embodiment of the invention provides a display apparatus having a decreased non-display area thereof and a digital information display (“DID”) device including a plurality of display apparatuses adjacent to each other.

An exemplary embodiment of the invention provides a display apparatus including a display panel and a backlight unit.

The display panel is divided into a display area in which an image is displayed with light and a non-display area disposed adjacent to the display area an in which an image is not displayed.

The backlight unit is disposed below the display panel to generate and provide light to the display panel.

The top cover is coupled to the display panel and the backlight unit. The top cover exposes the display area, and the top cover includes a base portion and a side portion provided in plural.

The base portion is disposed parallel to the display panel to cover the non-display area of the display panel.

Each of the side portions is connected to the base portion. Each of the side portions extends in a direction perpendicular to the non-display area.

In a top plan view, the base cover is disposed between each of the side portions and the display area.

In an exemplary embodiment, each of the side portions may have a flat plate shape.

In an exemplary embodiment, in the top plan view, each of the side portions of the top cover may protrude from an outer edge of the base portion and defines a predetermined thickness thereof with respect to the outer edge of the base portion.

In an exemplary embodiment, the base portion, which is disposed parallel to the display panel, may define a portion thereof perpendicular to the non-display area of the display panel to define the side portions of the top cover.

In an exemplary embodiment, the display area may have a rectangular shape. The base portion of the top cover may have a rectangular loop shape surrounding the display area. Each of the side portions may protrude from an outer edge of the base portion in a direction away from the display area.

In an exemplary embodiment, in the top plan view, the display area may define a first side thereof lengthwise extending in a first direction, the base portion may define a first portion thereof lengthwise extending in the first direction and disposed outside the first side of the display area, the side portions may include a first side portion provided in plural facing the first side of the display area with the first portion of the base portion disposed therebetween, and the first side portions may be spaced apart from each other in the first direction.

In an exemplary embodiment, in the top plan view, each of the first side portions may define two sides thereof lengthwise extending in a second direction perpendicular to the first direction.

In an exemplary embodiment, in the top plan view, the display area may further define a second side thereof lengthwise extending in a second direction perpendicular to the first direction and connected to the first side, the base portion may further define a second portion thereof lengthwise extending in the second direction and disposed outside the second side of the display area, and the side portions may further include a second side portion provided in plural facing the second side of the display area with the second portion of the base portion disposed therebetween.

The second side portions may be spaced apart from each other in the second direction, and each of the second side portions may define two opposing sides thereof lengthwise extending in the first direction.

In an exemplary embodiment, the first and second portions of the base portion may meet to define a corner of the base portion, at the corner of the base portion, the first side portion and the second side portion may be disposed spaced apart from each other with the corner therebetween, and the side portions may further include an outer portion which is extended from the corner of the base portion and connects the first side portion and the second side portion to each other.

In an exemplary embodiment, the display area may have the rectangular shape defining first to fourth sides thereof. The base portion of the top cover may define first to fourth portions thereof respectively disposed lengthwise extended along the first to fourth sides of the display area and outside the first to fourth sides. The first to fourth portions may have the same width as each other respectively defined from the first to fourth sides of the display area.

In an exemplary embodiment, the display area may have the rectangular shape defining first to fourth sides thereof. The base portion of the top cover may define first to fourth portions thereof respectively disposed lengthwise extended along the first to fourth sides of the display area and outside the first to fourth sides. Among the first to fourth portions of the base portion, each of two portions lengthwise extending in directions different from each other may have a first width, and each of the remaining two portions may have a second width that is less than the first width, the first and second widths each defined from a respective side of the display area.

In an exemplary embodiment of the invention, a DID device includes a plurality of display apparatuses arranged in an M×N matrix in first and second directions. Here, M and N are natural numbers.

The display apparatuses include first and second display apparatuses disposed adjacent to each other in the first direction.

The first display apparatus include a first display panel, a first backlight unit, and a first top cover coupled to the first display panel and the first backlight unit.

The second display apparatus includes a second display panel, a second backlight unit, and a second top cover coupled to the second display panel and the second backlight unit.

In a top plan view of the first and second display apparatuses disposed adjacent to each other in the first direction, an outer edge of each of the first and second top covers defines a concave-convex shape thereof, and the concave-convex shapes of the first and second top covers are engaged with each other.

In an exemplary embodiment, the first top cover may include a first base portion and first side portions. The first base portion may be disposed parallel to the first display panel to cover an edge portion of the first display panel. Each of the first side portions may be connected to the first base portion and extend in a thickness direction of the first display panel.

The second top cover may include a second base portion and second side portions. The second base portion may be disposed parallel to the second display panel to cover an edge portion of the second display panel. Each of the second side portions may be connected to the second base portion and extend in a thickness direction of the second display panel.

In the top plan view of the first and second display apparatuses disposed adjacent to each other in the first direction, a portion of the first side portions arranged in the second direction and a portion of the second side portions arranged in the second direction may be disposed between the first and second base portions and may be engaged with each other.

In an exemplary embodiment, the portion of the first side portions may contact the second base portion. The portion of the second side portions may contact the first base portion.

In an exemplary embodiment, the first base portion which is disposed parallel to the first display panel may define a portion thereof in the thickness direction of the first display panel to define the first side portions, and the second base portion which is disposed parallel to the second display panel may define a portion thereof in the thickness direction of the second display panel to define the second side portions.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain principles of the invention. In the drawings:

FIG. 1 is an exploded perspective view of an exemplary embodiment of a display apparatus according to the invention;

FIG. 2 is an enlarged perspective view illustrating a portion of an exemplary embodiment of a top cover corresponding to an area AA in the display apparatus of FIG. 1;

FIG. 3 is a top plan view of the display apparatus in FIG. 1;

FIG. 4 is a top plan view of a digital information display (“DID”) device including a display apparatus provided in plural according to the invention;

FIG. 5 is a perspective view illustrating a portion of a first top cover and a portion of a second top cover corresponding to an area BB in the DID of FIG. 4;

FIG. 6 is a cross-sectional view taken along line I-I′ of FIG. 4;

FIG. 7 is a top plan view of another exemplary embodiment of a display apparatus according to the invention; and

FIG. 8 is a top plan view of another exemplary embodiment of a DID device including a display apparatus provided in plural according to the invention.

### DETAILED DESCRIPTION

Since the present disclosure may have diverse modified embodiments, exemplary embodiments are illustrated in the drawings and are described in the detailed description of the invention. However, this does not limit the present disclosure within specific embodiments and it should be understood that the present disclosure covers all the modifications, equivalents, and replacements within the idea and technical scope of the invention. In the drawings, anything unnecessary for describing the present disclosure will be omitted for clarity, and also like reference numerals in the drawings denote like elements.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

A light receiving type display apparatus may include a display panel controlling a transmittance of incident light therethrough to display an image using the light and a backlight unit which generates and provides the light to the display panel. According to market demand, a width of a non-display area (e.g., a bezel) of the display apparatus has been decreased. However, as the width of the bezel decreases, a space in which inner components of the backlight unit are disposed decreases.

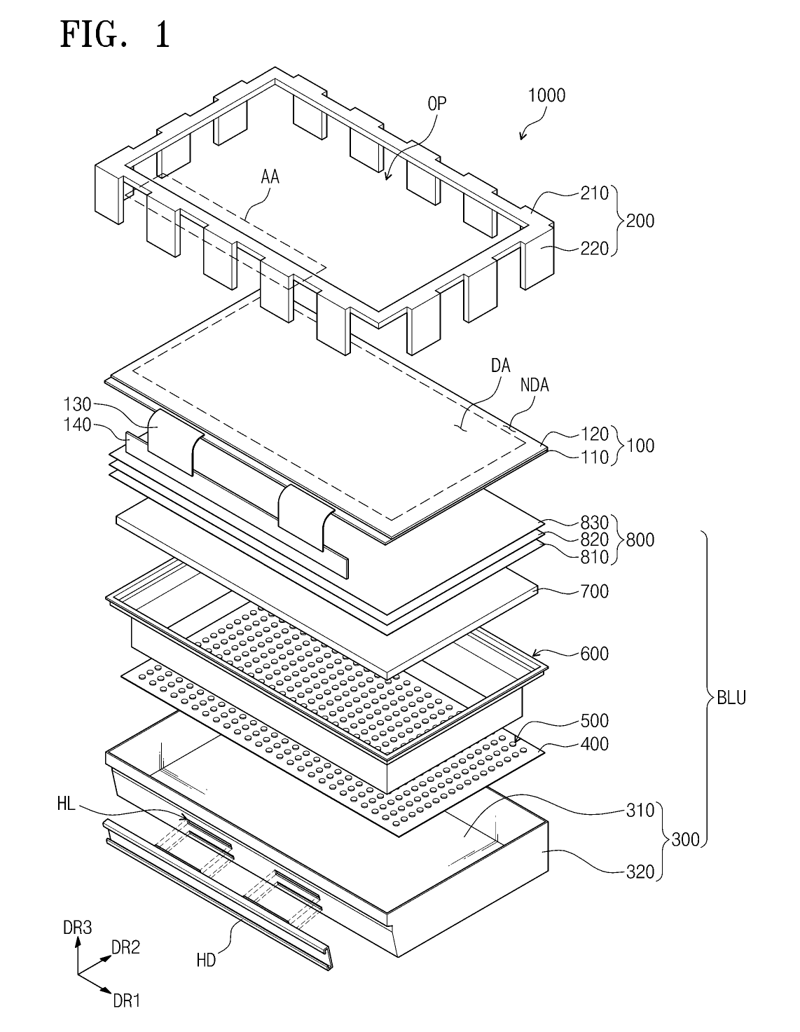

FIG. 1 is an exploded perspective view of an exemplary embodiment of a display apparatus 1000 according to the invention.

Referring to FIG. 1, the display apparatus 1000 may include a display panel 100, a top cover 200 and a backlight unit BLU.

The display panel 100 receives light from the backlight unit BLU to display an image. The display panel 100 is a light receiving type display panel like a liquid crystal display panel. Hereinafter, the display panel 100 including the liquid crystal display panel will be described as an example.

The display panel 100 includes a display area DA at which an image is displayed and a non-display area NDA surrounding the display area DA and at which an image is not displayed.

The display panel 100 may include a first display substrate 110, a second display substrate 120 facing the first display substrate 110, and a liquid crystal layer (not shown) disposed between the two substrates.

The first display substrate 110 may include gate lines, data lines, a thin film transistor and a pixel electrode, on a first base substrate. The gate lines and the data lines may insulatingly cross each other. The thin film transistor, which is a three-terminal device, is connected to one gate line, one data line and one pixel electrode. A data voltage applied to the data line according to a signal applied to the gate line may be applied to the pixel electrode.

The second display substrate 120 may faces the first display substrate 110 with the liquid crystal layer therebetween. Although the second display substrate 120 may include a color filter and a common electrode on a second base substrate, the invention is not limited thereto. For example, in another exemplary embodiment, at least one of the color filter and the common filter may be disposed in the first display substrate 110. According to another exemplary embodiment, the second display substrate 120 may be omitted, and the color filter, the common electrode and the liquid crystal layer may be sealed by an insulation layer in the first display substrate 120.

In a top plan view, the second display substrate 120 may have a planar size less than that of the first display substrate 110. The first display substrate 110 may be partially exposed by the second display substrate 120.

The liquid crystal layer may include a plurality of liquid crystal molecules for which orientations thereof are changed according to an electric field formed between the first display substrate 110 and the second display substrate 120.

FIG. 1 illustrates the display panel 100 having a rectangular shape in the top plan view. Also, FIG. 1 illustrates the display area DA having a rectangular shape in the top plan view. The display panel 100 may have a relatively long side lengthwise extending in a first direction DR1 and a relatively short side lengthwise extending in a second direction DR2. A direction of a thickness of the display panel 100 may be defined as a third direction DR3. The third direction DR3 may be orthogonal to both the first and second directions DR1 and DR2. The display panel 100 may be disposed extended in a plane defined by the first and second directions DR1 and DR2.

The display apparatus 1000 may further include a flexible printed circuit board 130 and a printed circuit board 140.

The flexible printed circuit board 130 is extended bent from the display panel 100 to electrically connect the display panel 100 to the printed circuit board 140. The flexible printed circuit board 130 may have a first end connected to one surface of the first display substrate 110, which is exposed by the second display substrate 120, and an opposing second end connected to the printed circuit board 140. The flexible printed circuit board 130 may be provided in plurality. A plurality of flexible printed circuit boards 130 may be spaced apart from each other in the first direction DR1. In FIG. 1, two flexible printed circuit boards 130 are provided as an example.

The printed circuit board 140 may be connected to the display panel 100. The printed circuit board 140 outputs a signal to the display panel 100 or receives a signal from the display panel 100 through the flexible printed circuit board 130.

According to an exemplary embodiment of the invention, an integrated circuit chip may be mounted on the flexible printed circuit board 130. A data driving circuit may be provided in the integrated circuit chip. Although the flexible printed circuit board 130 may be a tape carrier package (“TCP”) or a chip on film (“COF”), the invention is not limited thereto. In an exemplary embodiment, for example, the integrated circuit chip may be directly mounted on a surface of the first display substrate 110 instead of on the flexible printed circuit board 130.

A top cover 200 overlaps and covers an edge portion of the display panel 100 and is coupled to the display panel 100 and the backlight unit BLU. The top cover 200 includes or defines an opening OP at which the display area DA of the display panel 100 is exposed.

The top cover 200 may include or define a base cover (or base portion) 210 and a side cover or (side portion) 220 provided in plural. The base cover 210 may cover an edge portion of a top surface of the display panel 100. The base cover 210 may surround the non-display area NDA in the top plan view of the display apparatus 1000.

Each of the side covers 220 is connected to the base cover 210. The side covers 220 may lengthwise extend in the third direction DR3. The side covers 220 are disposed spaced apart from each other along a length of the sides of the display apparatus 1000, that is, along the first and second directions DR1 and DR2. The side covers 220 may respectively cover a portion of side surfaces of the display panel 100 and/or the backlight unit BLU. For purposes of description, reference numeral 220 is used to indicate both a single side cover (refer FIG. 1) and a group of side covers (FIG. 3).

The backlight unit BLU is disposed below the display panel 100 to generate and provide light to the display panel 100.

The backlight unit 200 may include a bottom cover 300, a reflective sheet 400, a light source 500 provided in plural, a middle mold 600, a diffusion plate 700, and optical sheets 800.

The bottom cover 300 may include or define a bottom part 310 and a sidewall 320.

The bottom part 310 may be flat. The bottom part 310 may have a rectangular shape on in the top plan view. The sidewall 320 may protrudingly extend from an edge portion of the bottom part 310. The sidewall 320 may be connected to four sides of the bottom part 310.

The reflective sheet 400 is disposed on the bottom part 310 and below the light sources 500. The reflective sheet 400 reflects most of incident light thereto.

The backlight unit BLU may further include a driving board (not shown). The driving board (not shown) may be disposed between the bottom part 310 and the reflective sheet 400. The driving board (not shown) may be electrically connected to the light sources 500 to provide a driving signal to the light sources 500. The driving board (not shown) may be provided in plurality.

The light sources 500 are accommodated into the bottom cover 300. The light sources 500 are disposed on the reflective sheet 400. The light sources 500 are provided as a direct-type light source to allow light generated and output from the light sources 500 is directly incident to the diffusion plate 700 without passing through a separate light guide plate.

Each of the light sources 500 may be a cold cathode fluorescent lamp (“CCFL”), a flat fluorescent lamp (“FFL”) or a light emitting diode (“LED”). Hereinafter, each of the light sources 500 as including the light emitting diode will be described as an example.

Although the light sources 500 may include white light sources generating and outputting white light, the invention is not limited thereto. In exemplary embodiments, for example, the light sources 500 may include a red light source generating and outputting red light, a green light source generating and outputting green light, and a blue light source generating and outputting blue light.

The middle mold 600 may be coupled to the bottom cover 310 and support the display panel 100 thereon.

The diffusion plate 700 may be supported by the middle mold 600. The diffusion plate 700 uniformly diffuses the light outputted from the light sources 500. That is, the diffusion plate 700 disperses light incident from the light sources 500 to reduce or effectively prevent the light from being locally concentrated.

The optical sheets 800 may be supported by the middle mold 600. The optical sheets 800 may include a diffusion sheet 810, a light collecting sheet 820 and a protection sheet 830. The diffusion sheet 810 may diffuse the incident light. The light collecting sheet 820 may increase luminance of the diffused light. The protection sheet 830 may protect the light collecting sheet 820 and secure a viewing angle. According to an exemplary embodiment of the invention, although three pieces of the optical sheets 800 are provided as an example, the invention is not limited thereto. In an exemplary embodiment, for example, the optical sheets 800 may include at least four sheets. Also, the diffusion sheet 810 may be omitted, and the optical sheets 800 may include the light collecting sheet 820 and the protection sheet 830.

The optical sheet (e.g., the protection sheet 830 in FIG. 1) disposed at an uppermost portion among the optical sheets 800 may contact the display panel 100.

The diffusion plate 700 and the optical sheets 800 may be spaced a predetermined distance from each other in the third direction DR3. Accordingly, when the diffusion plate 700 and the optical sheets 800 within the display apparatus 100 are transported, wear-out caused by friction therebetween may be reduced or effectively prevented.

The display apparatus 1000 may further include a holder HD. The holder HD may be coupled to the sidewall 320. In detail, the holder HD may be inserted into and fixed to a hole HL provided in the sidewall 320. A plurality holes HL that are spaced apart from each other may be provided in the sidewall 320. The flexible printed circuit board 130 may be bent toward the sidewall 320 from the display panel 100, and the printed circuit board 140 may be accommodated in the holder HD.

Referring to FIG. 1, according to an exemplary embodiment of the invention, although the backlight unit BLU including the direct type light sources 500 is described as an example, the invention is not limited thereto. According to another exemplary embodiment of the invention, the backlight unit BLU may include an edge type light source and a light guide plate guiding light which is generated and output from the edge type light sources.

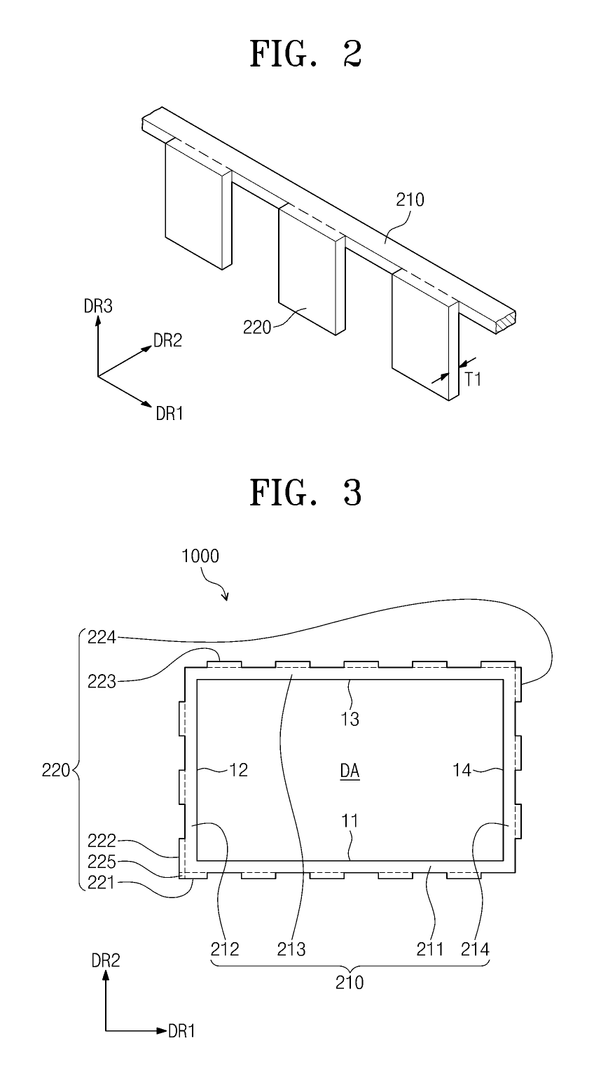

FIG. 2 is an enlarged perspective view illustrating a portion of an exemplary embodiment of a top cover corresponding to an area AA in the display apparatus of FIG. 1.

Referring to FIG. 2, each of the side covers 220 may have a flat plate shape. The side covers 220 may have a uniform thickness T1 in a direction perpendicular to a direction in which the base cover 210 extends. A portion of a side surface of the backlight unit BLU and a portion of a side surface of the display panel 100 may be exposed between side covers 220 adjacent to each other in the first and second directions DR1 and DR2.

The base cover 210 and side covers 220 may be integrated with each other. The base cover 210 and side covers 220 which extend therefrom may define a single, unitary top cover 200. The base cover 210 which covers the non-display area of the display panel 100 may extend perpendicular to the non-display area to define the side covers 220, such as to form the single, unitary (integrated) top cover 200.

FIG. 3 is a top plan view of the display apparatus in FIG. 1.

Referring to FIG. 3, the characteristics of the top cover 200 in the top plan view will be described.

In the top plan view, the base cover 210 may be respectively disposed between each of plural side covers 220 and the display area DA. In the top plan view, the base cover 210 may have a rectangular loop shape surrounding the display area DA.

In the top plan view, the side covers 220 may protrude a thickness T1 from an outer edge of the base cover 210 in a direction away from the display area DA. The outer edge of the base cover 210 at the side covers 220 is indicated by the dotted lines in FIG. 3. The thickness T1 of a side cover 220 is taken in a direction perpendicular to the length of the base cover 210 from which the side cover 220 protrudes.

The display area DA may include or define first to fourth sides 11 to 14. Each of the first and third sides 11 and 13 may extend lengthwise in the first direction DR1, and each of the second and fourth sides 12 and 14 may extend lengthwise in the second direction DR2.

The base cover 210 may include first to fourth portions 211 to 214. In the top plan view, the first portion 211 is disposed outside the first side 11, the second portion 212 is disposed outside the second side 12, the third portion 213 is disposed outside the third side 12, and the fourth portion 214 is disposed outside the fourth side 14. According to an exemplary embodiment of the invention, widths of the first to fourth portions 211 to 214 may be the same as each other. The widths of the first to fourth portions 211 to 214 may be measured in a direction perpendicular to a direction in which each of the first to fourth portions 211 to 214 lengthwise extends. The widths of the first to fourth portions 211 to 214 of the base cover 210 are respectively taken in a same direction as the thicknesses T1 of the side covers 220 protruded from the first to fourth portions 211 to 214.

The side covers 220 may collectively include first to fourth side covers 221 to 224 and an outer side cover 225. Each of the first to fourth side covers 221 to 224 may be provided in plural along a respective side of the display area DA.

The first side covers 221 may face the first side 11 of the display area DA with the first portion 211 of the base cover 210 therebetween. The second side covers 222 may face the second side 12 of the display area DA with the second portion 212 of the base cover 210 therebetween. The third side covers 223 may face the third side 13 of the display area DA with the third portion 213 of the base cover 210 therebetween. The fourth side covers 224 may face the fourth side 14 of the display area DA with the fourth portion 214 of the base cover 210 therebetween.

The first side covers 221 may be spaced apart from each other in the first direction DR1. The third side covers 223 may be spaced apart from each other in the first direction DR1. The second side covers 222 may be spaced apart from each other in the second direction DR2. The fourth side covers 224 may be spaced apart from each other in the second direction DR2.

Each of the first side covers 221 may have a rectangular shape in the top plan view. Each of the first side covers 221 may have or define two sides extending in the second direction DR2 and two sides extending in the first direction DR1. Similarly, the second to fourth side covers 222 to 224 may have or define two sides extending in the second direction DR2 and two sides extending in the first direction DR1.

The base cover 210 may define corners thereof at which outer edges of the first to fourth portions 211 to 214 meet. The outer side cover 225 is disposed at a corner of the base cover 210. The outer side cover 225 may be connected to one of the first side covers 221 and one of the second side covers 222 adjacent to each other along the periphery of the base cover 210. The connected one of the first side covers 221, the connected one of the second side covers 222, and the outer side cover 225 may be integrated with each other. The first side cover 221, the second side cover 222 and the outer side cover 225 connected to each other may define a single unitary side cover member.

In the display apparatus 1000 according to one or more exemplary embodiment of the invention, an outer edge of the top cover 200 may be defined by outer edges of the side covers 220 and the base cover 210 in the top plan view. The display apparatus 1000 may be provided in plural engaged with and coupled to each other by respective top covers 200 thereof. Within the plural display apparatuses 1000, an overall non-display area NDA thereof may decrease in multiples of the thickness of each of the side covers 220 thereof.

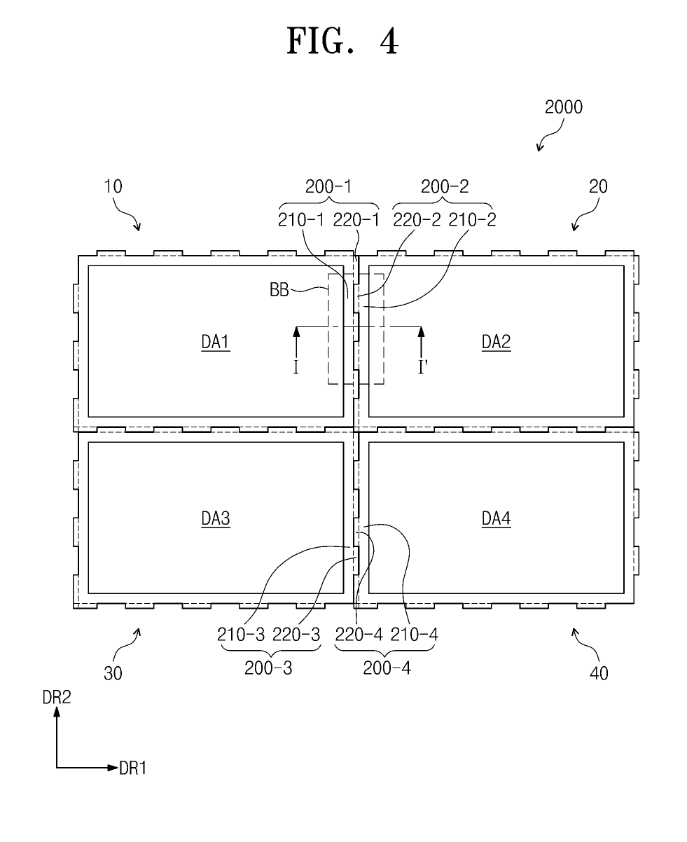

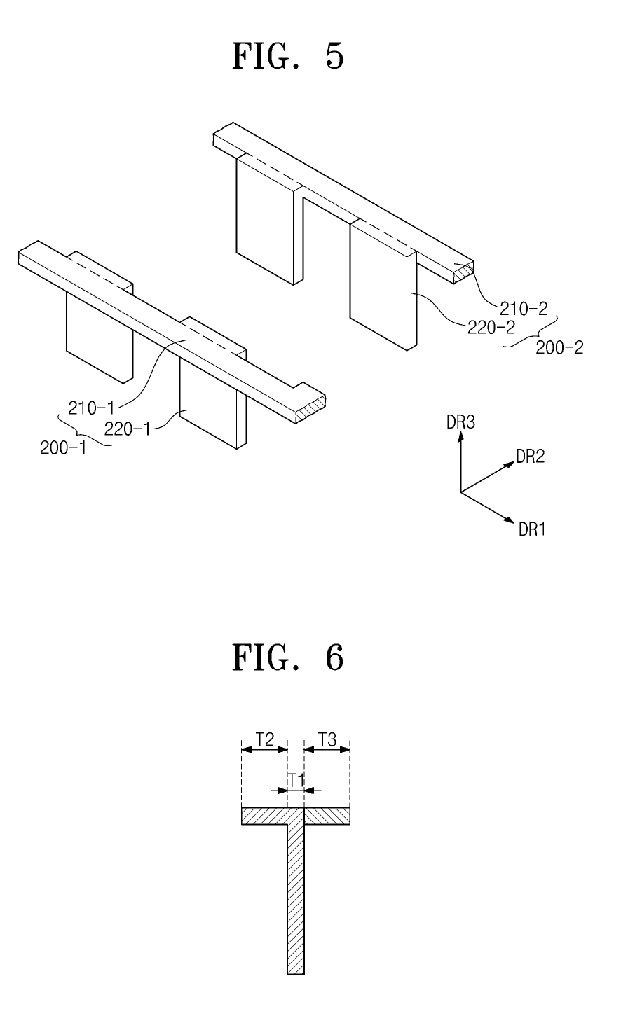

FIG. 4 is a top plan view of an exemplary embodiment of a digital information display (“DID”) device including a display apparatus provided in plural according to the invention, and FIG. 5 is a perspective view illustrating a portion of a first top cover and a portion of a second top cover corresponding to an area BB in the DID of FIG. 4.

Hereinafter, the DID device 2000 will be described with reference to FIGS. 4 and 5.

Although the DID device 2000 includes first to fourth display apparatuses 10 to 40 that are arranged in a 2×2 matrix form in FIG. 4, the invention is not limited thereto. In exemplary embodiments, for example, the DID device 2000 may include display apparatuses that are arranged in various matrix forms in addition to the 2×2 matrix form, such as including less or more than two display apparatuses in the first direction DR1 and/or less or more than two display apparatuses in the second direction DR2.

The first to fourth display apparatuses 10 to 40 may be the same as each other.

The first display apparatus 10 may include a first display panel, a first backlight unit and a first top cover 200-1. The second display apparatus 20 may include a second display panel, a second backlight unit and a second top cover 200-2. The third display apparatus 30 may include a third display panel, a third backlight unit and a third top cover 200-3. The fourth display apparatus 40 may include a fourth display panel, a fourth backlight unit and a fourth top cover 200-4.

First to fourth display areas DA1 to DA4 may be respectively defined in the first to fourth display panels 10 to 40. Each of the first to fourth display areas DA1 to DA4 may be an area at which an image is displayed. In the DID device 2000, areas between the first to fourth display areas DA1 to DA4 and areas outside the first to fourth display areas DA1 to DA4 may be defined as a non-display area.

Since the first to fourth display panels have the same structure as each other and are the same as the display panel 100 described with reference to FIG. 1, detailed description will be omitted. Since the first to fourth backlight units have the same structure as each other and are the same as the backlight unit BLU described with reference to FIG. 1, detailed description will be omitted.

An outer edge of each of the first to fourth top covers 200-1 to 200-4 is defined in the top plan view. Among the first to fourth top covers 200-1 to 200-4, top covers adjacent to each other in the first direction DR1 and in the second direction DR2 may be engaged with each other. Referring to FIG. 4, for example, the first top cover 200-1 may be coupled to the second top cover 200-2 adjacent in the first direction DR1.

For each top cover, a concave portion thereof may be defined with a portion of the outer edge of a base cover between adjacent side covers and sides of the adjacent side covers. A concave portion may be defined at a length portion of the base cover or at a corner portion of the base cover. A convex portion of each top cover may be defined by a side cover protruded from the outer edge of a base cover. A convex portion may be defined at a length portion of the base cover or at a corner portion of the base cover (e.g., the outer side cover 225 in FIG. 3).

Referring to FIG. 4, for example, a concave portion of the first top cover 200-1 may be engaged with a convex portion of the second top cover 200-2 adjacent in the first direction DR1. Similarly, the third top cover 200-3 may be engaged with the fourth top cover 200-4 adjacent in the first direction DR1, the first top cover 200-1 may be engaged with the third top cover 200-3 adjacent in the second direction DR2, and the second top cover 200-2 may be engaged with the fourth top cover 200-4 adjacent in the second direction DR2.

The first top cover 200-1 may include or define a first base cover 210-1 and a first side cover 220-1 provided in plural. The second top cover 200-2 may include or define a second base cover 210-2 and a second side cover 220-2 provided in plural. The third top cover 200-3 may include or define a third base cover 210-3 and a third side cover 220-3 provided in plural. The fourth top cover 200-4 may include or define a fourth base cover 210-4 and a fourth side cover 220-4 provided in plural.

A portion of the first side covers 220-1 and a portion of the second side covers 220-2, which are disposed between the first base cover 210-1 and the second base cover 210-2 adjacent in the first direction DR1, may be alternately disposed in the second direction DR2. A portion of the first side covers 220-1, which is disposed between the first base cover 210-1 and the second base cover 210-2, may contact the second base cover 210-2. Similarly, a portion of the second side covers 220-2, which is disposed between the first base cover 210-1 and the second base cover 210-2, may contact the first base cover 210-1.

A portion of the third side covers 220-3 and a portion of the fourth side covers 220-4, which are disposed between the third base cover 210-3 and the fourth base cover 210-4 adjacent in the first direction DR1, may be alternately disposed in the second direction DR2. A portion of the third side covers 220-3, which is disposed between the third base cover 210-3 and the fourth base cover 210-4, may contact the fourth base cover 210-4. Similarly, a portion of the fourth side covers 220-4, which is disposed between the third base cover 210-3 and the fourth base cover 210-4, may contact the third base cover 210-3.

A portion of the first side covers 220-1 and a portion of the third side covers 220-3, which are disposed between the first base cover 210-1 and the third base cover 210-3 adjacent in the second direction DR2, may be alternately disposed in the first direction DR1. A portion of the first side covers 220-1, which is disposed between the first base cover 210-1 and the third base cover 210-3, may contact the third base cover 210-3. Similarly, a portion of the third side covers 220-3, which is disposed between the first base cover 210-1 and the third base cover 210-3, may contact the first base cover 210-1.

A portion of the second side covers 220-2 and a portion of the fourth side covers 220-4, which are disposed between the second base cover 210-2 and the fourth base cover 210-4 adjacent in the second direction DR2, may be alternately disposed in the first direction DR1. A portion of the second side covers 220-2, which is disposed between the second base cover 210-2 and the fourth base cover 210-4, may contact the fourth base cover 210-4. Similarly, a portion of the fourth side covers 220-4, which is disposed between the second base cover 210-2 and the fourth base cover 210-4, may contact the second base cover 210-2.

FIG. 6 is a cross-sectional view taken along line I-I′ of FIG. 4.

Referring to FIGS. 4 and 6, in a top plan view, a size of the non-display area between the display areas DA1 to DA4 may be determined by the first to fourth top covers 200-1 to 200-4. In an exemplary embodiment, for example, a total width, which is measured in the first direction DR1, of the non-display area defined between the first and second display areas DA1 and DA2 may be the same as a sum of a width T2 of the first base cover 210-1, a width T3 of the second base cover 210-2, and a thickness T1 of the first side cover 220-1.

Referring to FIG. 6, among two top covers adjacent to each other in a direction, a side cover of one top cover is not disposed facing a side cover of the other top cover. That is, instead of two thicknesses (T1+T1) disposed in the adjacent direction to define a non-display area, there is only one thickness T1 in the adjacent direction to define the non-display area. Since there is only one thickness T1 in the adjacent direction, a total width of the non-display area in the adjacent direction is reduced by one thickness T1.

In one or more exemplary embodiment of the DID device 2000 according to the invention, the first to fourth top covers 200-1 to 200-4 may be respectively engaged with and coupled to each other to decrease a non-display area defined between adjacent display apparatuses. Since Accordingly, a width of the non-display area of the DID device 2000 may decrease by the thickness T1 of each of the first to fourth side covers 220-1 to 220-4.

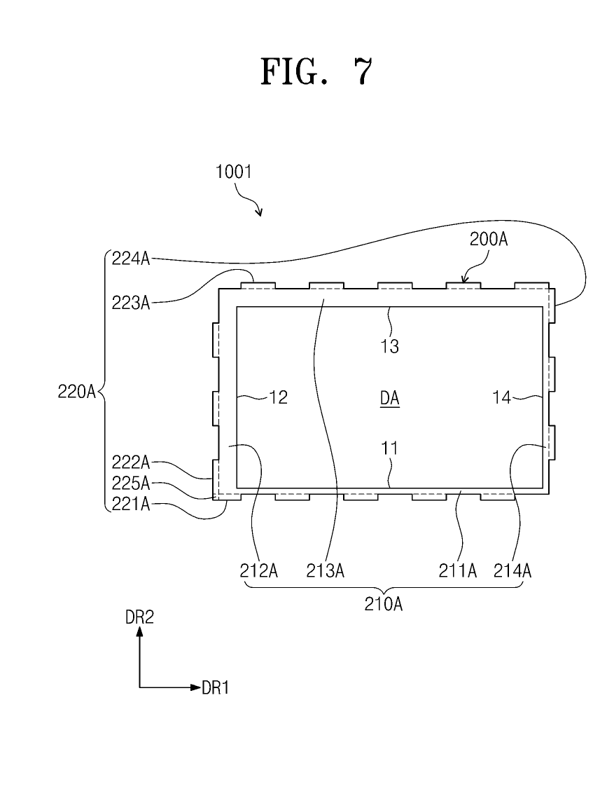

FIG. 7 is a top plan view of another exemplary embodiment of a display apparatus according to the invention.

A display apparatus 1001 in FIG. 7 is substantially the same as the display apparatus 1000 in FIG. 3, except for a top cover 200A.

The top cover 200A may include or define a base cover 210A and side covers 220A. The side covers 220A may collectively include first to fourth side covers 221A to 224A and an outer side cover 225A. Each of the first to fourth side covers 221A to 224A may be provided in plural along a respective side of the display area DA.

The base cover 210A may include first to fourth portions 211A to 214A. In the top plan view, the first portion 211A is disposed outside a first side 11 of the display area DA, the second portion 212A is disposed outside a second side 12 of the display area DA, the third portion 213A is disposed outside a third side 13 of the display area DA, and the fourth portion 214A is disposed outside a fourth side 14 of the display area DA.

Two portions extending in directions different from each other among the first to fourth portions 211A to 214A of the base cover 210A may have a width greater than that of a remainder of the first to fourth portions 211A to 214A. Here, the width of the first to fourth portions 211A to 214A may be measured in a direction perpendicular to a direction in which each of the first to fourth portions 211A to 214A extends. The widths of the first to fourth portions 211A to 214A of the base cover 210A are respectively taken in a same direction as the thicknesses T1 of the side covers 220A respectively protruded from the first to fourth portions 211A to 214A.

In FIG. 7, the first and fourth portions 211A and 214A have or define a width less than that of the second and third portions 212A and 213A as an example, but the invention is not limited thereto. In an exemplary embodiment, for example, the second and third portions 212A and 213A may overlap a flexible printed circuit board (refer to 130 in FIG. 1) that is bonded to a display panel (refer to 100 in FIG. 1) of the display apparatus 1001. The first and fourth portions 211A and 214A may not overlap the flexible printed circuit board that is bonded to the display panel. The second and third portions 212A and 213A may have a width greater than that of the first and fourth portions 211A and 214A to cover the flexible printed circuit board.

A sum of the widths of the first and third portions 211A and 213A may be the same as that of the widths of the second and fourth portions 212A and 214A.

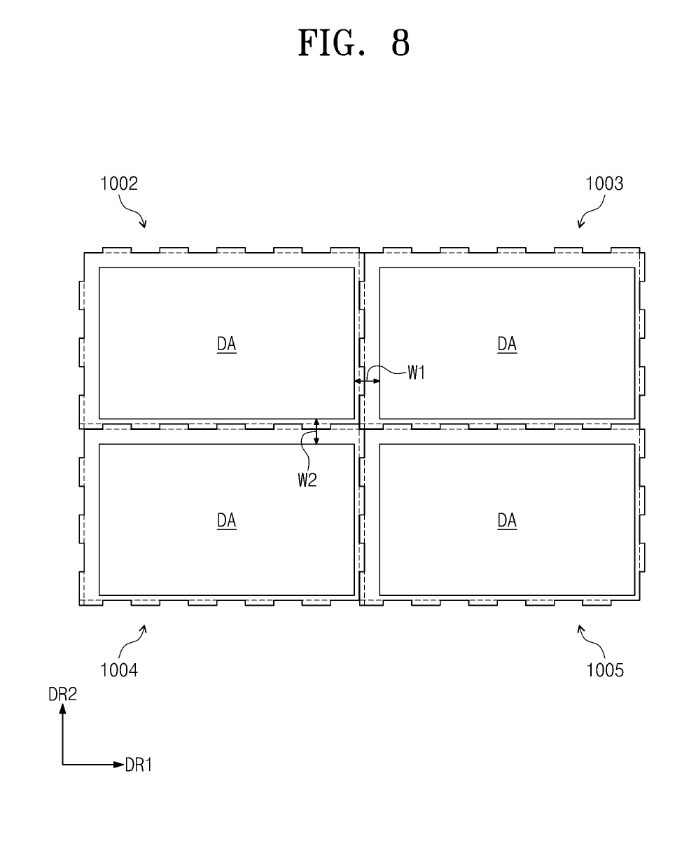

FIG. 8 is a top plan view of another exemplary embodiment of a DID device according to the invention.

A DID device 2001 may include a plurality of display apparatuses 1002 to 1005 that are engaged with and coupled to each other. Each of the plurality of display apparatuses 1002 to 1005 may be the same as the display apparatus 1001 in FIG. 7.

Referring to FIGS. 7 and 8, since a sum of the widths of the first and third portions 211A and 213A is the same as that of the widths of the second and fourth portions 212A and 214A, in the DID device 2001, a total width W1 of the non-display area between the display areas DA adjacent in the first direction DR1 may be the same as a total width W2 of the non-display area between the display areas DA adjacent in the second direction DR2.

Referring to FIGS. 7 and 8, among two top covers adjacent to each other in a direction, a side cover of one top cover is not disposed facing a side cover of the other top cover. That is, instead of two thicknesses (T1+T1) disposed in the adjacent direction to define a non-display area, there is only one thickness T1 in the adjacent direction to define the non-display area. Since there is only one thickness T1 in the adjacent direction, the widths W1 and W2 of the non-display area in the adjacent direction is reduced by one thickness T1.

According to one or more exemplary embodiment of the invention, the display apparatus and the DID device including a plurality of display apparatuses may decrease the non-display area defined between adjacent display apparatuses.

The scope of the present disclosure is not limited to the exemplary embodiments described above but is defined by the appended claims. It is evident, however, that many alternative modifications and variations will be apparent to those having skill in the art in light of the foregoing description. Thus, those various changes may be made without departing from the scope and spirit of the invention.

What is claimed is:

1. A display apparatus comprising:
a display panel which defines a display area in which an image is displayed with light and a non-display area which is disposed adjacent to the display area and in which the image is not displayed;
a backlight unit which is disposed below the display panel and generates and provides the light to the display panel; and
a top cover which is coupled to the display panel and the backlight unit and exposes the display area of the display panel, wherein the top cover comprises:
a base portion disposed parallel to the display panel to cover the non-display area of the display panel; and
a side portion provided in plural each of which is connected to the base portion and extends in a direction perpendicular to the non-display area of the display panel, at least two of the plurality of the side portions are spaced apart from each other,
wherein in a top plan view, the base portion of the top cover is disposed between the side portions of the top cover and the display area of the display panel.

2. The display apparatus of claim 1, wherein each of the side portions of the top cover has a flat plate shape.

3. The display apparatus of claim 2, wherein in the top plan view, each of the side portions of the top cover protrudes from an outer edge of the base portion and defines a predetermined thickness thereof with respect to the outer edge of the base portion.

4. The display apparatus of claim 1, wherein the base portion and the side portion are integrated with each other.

5. The display apparatus of claim 1, wherein in the top plan view,
the display area has a rectangular shape,
the base portion of the top cover has a rectangular loop shape surrounding the display area, and
each of the side portions protrudes from an outer edge of the base portion in a direction away from the display area.

6. The display apparatus of claim 5, wherein in the top plan view,
the display area defines a first side thereof lengthwise extending in a first direction,
the base portion defines a first portion thereof lengthwise extending in the first direction and disposed outside the first side of the display area,
the side portions comprise a first side portion provided in plural facing the first side of the display area with the first portion of the base portion disposed therebetween, and
the first side portions are spaced apart from each other in the first direction.

7. The display apparatus of claim 6, wherein in the top plan view, each of the first side portions defines two opposing sides thereof lengthwise extending in a second direction perpendicular to the first direction.

8. The display apparatus of claim 6, wherein in the top plan view,
the display area further defines a second side thereof lengthwise extending in a second direction perpendicular to the first direction and connected to the first side,
the base portion further defines a second portion thereof lengthwise extending in the second direction and disposed outside the second side of the display area,
the side portions further comprise a second side portion provided in plural facing the second side of the display area with the second portion of the base portion disposed therebetween,
the second side portions are spaced apart from each other in the second direction, and
each of the second side portions defines two opposing sides thereof lengthwise extending in the first direction.

9. The display apparatus of claim 8, wherein
the first and second portions of the base portion meet to define a corner of the base portion,
at the corner of the base portion, the first side portion and the second side portion are disposed spaced apart from each other with the corner therebetween, and
the side portions further comprise an outer portion which is extended from the corner of the base portion and connects the first side portion and the second side portion to each other.

10. The display apparatus of claim 5, wherein in the top plan view,
the display area has the rectangular shape defining first to fourth sides thereof,
the base portion of the top cover defines first to fourth portions thereof respectively disposed lengthwise extended along the first to fourth sides of the display area and outside the first to fourth sides of the display area, and
the first to fourth portions have the same width as each other respectively defined from the first to fourth sides of the display area.

11. The display apparatus of claim 5, wherein in the top plan view,
the display area has the rectangular shape defining first to fourth sides thereof,
the base portion of the top cover defines first to fourth portions thereof respectively disposed lengthwise extended along the first to fourth sides of the display area and outside the first to fourth sides of the display area, and
among the first to fourth portions of the base portion, each of two portions lengthwise extending in directions different from each other has a first width, and each of the remaining two portions has a second width that is less than the first width, the first and second widths each defined from a respective side of the display area.

12. A digital information display device comprising:
a plurality of display apparatuses arranged in an M×N matrix in first and second directions, where M and N are natural numbers,
wherein
the display apparatuses comprise first and second display apparatuses disposed adjacent to each other in the first direction,
the first display apparatus comprises a first display panel, a first backlight unit, and a first top cover coupled to the first display panel and the first backlight unit,
the second display apparatus comprises a second display panel, a second backlight unit, and a second top cover coupled to the second display panel and the second backlight unit, and
in a top plan view of the first and second display apparatuses disposed adjacent to each other in the first direction, an outer edge of each of the first and second top covers defines a concave-convex shape thereof, and the concave-convex shapes of the first and second top covers are engaged with each other.

13. The digital information display device of claim 12, wherein
the first top cover defines:
a first base portion disposed parallel to the first display panel to cover an edge portion of the first display panel; and
a plurality of first side portions each of which is connected to the first base portion and extends in a thickness direction of the first display panel,
the second top cover comprises:
a second base portion disposed parallel to the second display panel to cover an edge portion of the second display panel; and
a plurality of second side portions each of which is connected to the second base portion and extends in a thickness direction of the second display panel, and
in the top plan view of the first and second display apparatuses disposed adjacent to each other in the first direction, a portion of the first side portions arranged in the second direction and a portion of the second side portions arranged in the second direction are disposed between the first and second base portions and are engaged with each other.

14. The digital information display device of claim 13, wherein
the portion of the first side portions contacts the second base portion, and
the portion of the second side portion contacts the first base portion.

15. The digital information display device of claim 13, wherein the first side portions and the first base portion are integrated with each other, and the second side portions and the second base cover are integrated with each other.

16. The digital information display device of claim 13, wherein in the top plan view of the first and second display apparatuses disposed adjacent to each other in the first direction,
the first side portions of the first top cover respectively extend into concave portions of the second top cover to alternate with the second side portions of the second top cover in the second direction, and
the second side portions of the second top cover respectively extend into concave portions of the first top cover to alternate with the first side portions of the first top cover in the second direction.
